(19) United States
(12) Patent Application Publication
(10) Pub. No.: US 2009/0109127 A1
(43) Pub. Date: Apr. 30, 2009

(54) Three-Dimensional Image Display Device and a Displaying Method Thereof

(75) Inventors: Ching-Chao Chang, Tao-Yuan Hsien (TW); Hung-Chang Chang, Tao-Yuan Hsien (TW); Chien-Yung Cheng, Tao-Yuan Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORPORATION, Taipei County (TW)

(21) Appl. No.: 12/054,957

(22) Filed: Mar. 25, 2008

(30) Foreign Application Priority Data
Oct. 24, 2007 (TW) 96139940

(51) Int. Cl. G09G 5/00

(52) U.S. Cl. 345/6

(57) ABSTRACT

A three-dimensional image display device and a displaying method thereof. The display device includes a pixel array, a sub-pixel rendering device and a mask. The sub-pixel rendering device provides data signals to the sub-pixels to form the first frames and the second frames. The first frame and the second frame include a plurality of first pixel regions and a plurality of second pixel regions. The second pixel region and the adjacent first pixel regions have some sub-pixels in common. The mask projects the first frames and the second frames as a first image and a second image.

### BACKGROUND

This application claims priority to Taiwan Application Serial Number 96139940, filed Oct. 24, 2007, which is herein incorporated by reference.

### FIELD OF INVENTION

The present invention relates to a display device and a displaying method thereof. More particularly, the present invention relates to a three-dimensional display device and a three-dimensional displaying method thereof.

### DESCRIPTION OF RELATED ART

To meet the requirements for reproducing natural images, display technology has gradually changed from the two-dimensional displays to the three-dimensional displays. As early as Euclid and Aristotle's age, people noted that although there are two eyes receiving different images, people are prevented from suffering from double image problems. After a lot of animal and human tests, the human brain's ability to reproduce in depth images received from different angles by the left eye and the right eye has been proved.

The three-dimensional vision is formed because of the binocular parallax phenomenon, which is caused as a result of receiving images from different angles by the left eye and right eye. The images of different angles are merged to reproduce three-dimensional images by the human brain. The three-dimensional image displaying technique includes the stereoscopic form and the auto-stereoscopic form. The stereoscopic form makes the user un-comfortable, therefore the stereoscopic form is not popular. On the other hand, the auto-stereoscopic form has become more and more popular.

In order to form three-dimensional vision, the auto-stereoscopic method divides the image into right eye regions and left eye regions, which are projected to the right eye and left eye of the user simultaneously with a parallax barrier or micro-lens arrays. The division reduces the number of image pixels received by the right eye or the left eye to half of the original image pixels number, which reduces the resolution and affects the image quality.

Hence, there is a need for a new display technology which can produce three-dimensional vision and maintain the resolution at the same time.

### SUMMARY

According to one embodiment of the present invention, a three-dimensional image display device is disclosed. The display device includes a pixel array, a sub-pixel rendering device and a mask. The sub-pixel rendering device provides data signals to the sub-pixels to form the first frames and the second frames. The first frame and the second frame include a plurality of first pixel regions and a plurality of second pixel regions. The second pixel region and the adjacent first pixel regions have some sub-pixels in common. The mask projects the first frames and the second frames as a first image and a second image.

According to another embodiment of the present invention, a method for displaying three-dimensional images includes forming a plurality of first frames and a plurality of second frames with a plurality of sub-pixels, defining the first frames as a plurality of first pixel regions and a plurality of second pixel regions, and defining the second frames as the first pixel regions and the second pixel regions in which each second pixel region has some sub-pixels in common with the adjacent first pixel regions, and each first frame doesn't overlap the second frames.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the concept of the three-dimensional image display according to one embodiment of the present invention;

FIG. 2A shows the pixel array with sub-pixels arranged in strip shape according to one embodiment of the present invention;

FIG. 2B shows the pixel array with sub-pixels disposed interlaced according to one embodiment of the present invention;

FIG. 2C shows the interlaced pixel array which includes white sub-pixels according to one embodiment of the present invention;

FIG. 3A and FIG. 3B show the arrangement of the first frames, the second frames, and the sub-pixels of the RGB pixel array according to one embodiment of the present invention;

FIG. 3C and FIG. 3D show the arrangement of the first frames, the second frames, and the sub-pixels of the RGBW pixel array according to one embodiment of the present invention;

FIG. 4 shows the RGBW three-dimensional image display device according to one embodiment of the present invention; and

FIG. 5 shows the method for displaying the three-dimensional images according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The three-dimensional image display device as well as the displaying method shown in the following embodiments generate additional second pixel regions with the sub-pixel rendering technique, which enables the observers to have a three-dimensional vision of the image while the resolution is kept the same at the same time. Hence, the image quality has been improved.

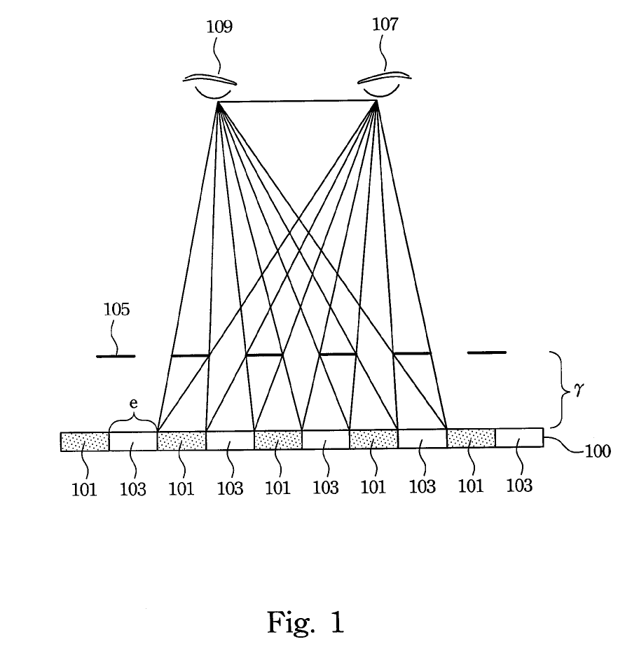

FIG. 1 shows the concept of the three-dimensional image display according to one embodiment of the present invention. The pixel regions of the pixel array 100 are defined as left-eye images 101 and right-eye images 103, in which each right-eye image 103 is disposed between two of the left-eye images 101.

The mask 105 can be made of liquid crystal or other material such as plastic, class, or metal. The mask 105 is disposed between the pixel array 100 and a viewer, and is disposed at a pre-determined distance r from the pixel array 100. The pre-determined distance r is corresponding to the size of the pixel region, the distance between the viewer and the pixel array 100, and the distance e from one left-eye image 101 to another left-eye image 101. When the viewer wants to see three-dimensional images, some parts of the mask 105 become non-transparent, which blocks the right eye 109 of the viewer from receiving the left-eye images 101, and also blocks the left eye 107 of the viewer from receiving the right-eye images 103.

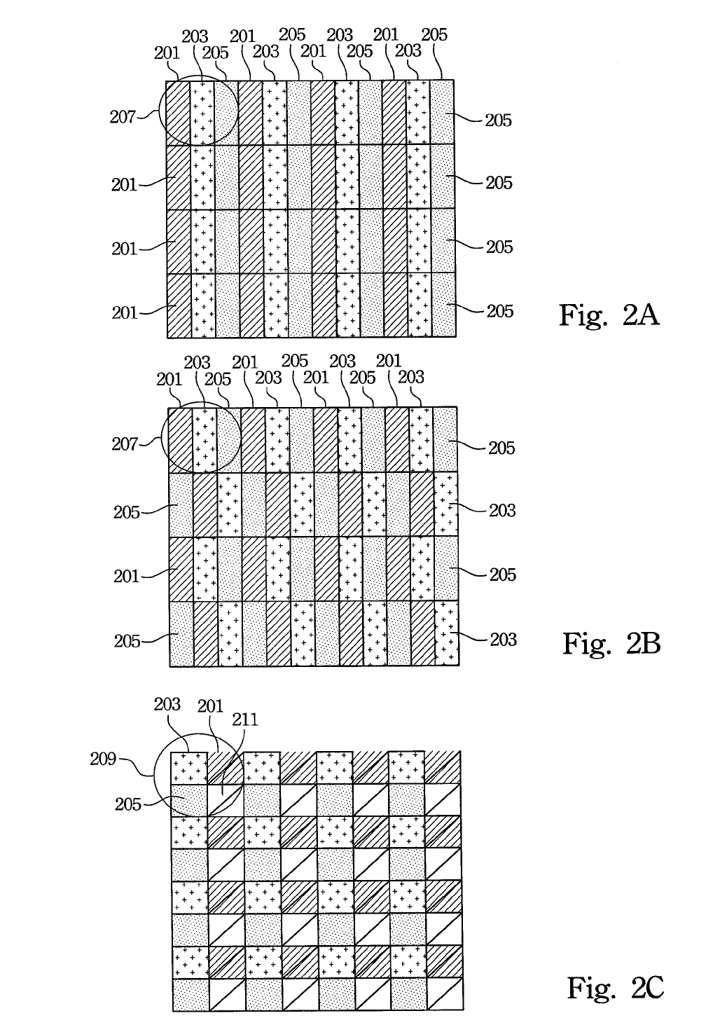

FIG. 2A, FIG. 2B and FIG. 2C show the pixel array with the sub-pixels arranged in various forms according to the embodiments of the present invention. In the pixel array shown in FIG. 2A and FIG. 2B, each pixel region 207 includes the red sub-pixels 201, the green sub-pixels 203, and the blue sub-pixels 205. Each sub-pixel is electrically connected to the corresponding data line for receiving the pixel voltage (gray voltage) in order to display images. Unlike the sub-pixels arranged in strip shape show in FIG. 2A, the red sub-pixels 201, the green sub-pixels 203, and the blue sub-pixels 205 of the pixel array shown in FIG. 2B are interlaced disposed.

In the pixel array shown in FIG. 2C, except the three color sub-pixels, each pixel region 209 further includes the white sub-pixel 211. Therefore, the brightness and the contrast can be improved. The examples of sub-pixel arrangement of the pixel array are shown in FIG. 2A, FIG. 2B and FIG. 2C. The sub-pixel arrangement of the pixel array of the present invention is not limited to those shown in the examples.

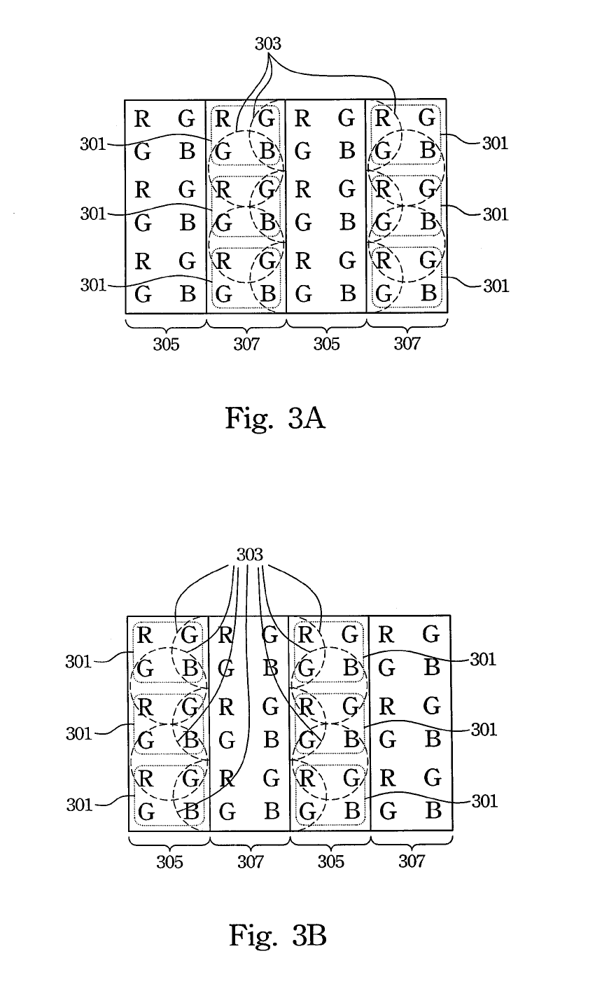

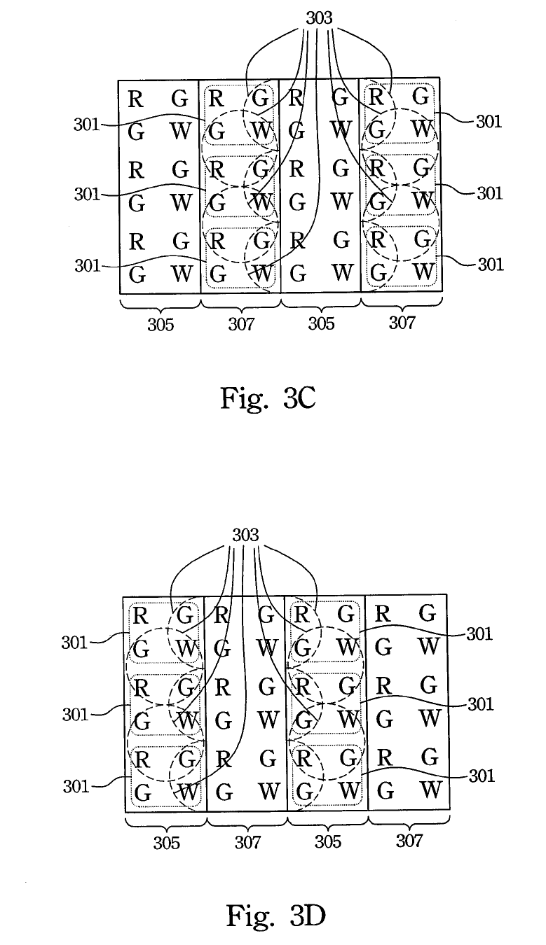

FIG. 3A, FIG. 3B, FIG. 3C and FIG. 3D show the arrangement of the first frames, the second frames, and the sub-pixels of the pixel array according to one embodiment of the present invention. FIG. 3A and FIG. 3B show the RGB pixel array, while FIG. 3C and FIG. 3D show the RGBW pixel arrays. In the pixel array, the adjacent sub-pixels (R, G, B, W) are grouped as the first pixel region 301 or the second pixel region 303 by the control signals and data signals (not shown). The first frames 305 and the second frames 307 include individual first pixel regions 301 and second pixel regions 303 for displaying the first images and the second images.

The sub-pixels (R, G, B/R, G, B, W) covered in first frames 305 having positions different from the sub-pixels covered in the second frame 307. The first frame 305 and the second frame 307 are disposed interlaced. In the same one first frame 305, the second pixel regions 303 share some common sub-pixels with the adjacent first pixel regions 301. In different first frames 305, the first pixel regions 301 share some common sub-pixels with the adjacent second pixel region 303. Similarly, in the same one second frame 307, the second pixel regions 303 share some common sub-pixels with the adjacent first pixel regions 301. In different second frames 307, the first pixel regions 301 share some common sub-pixels with the adjacent second pixel region 303. The first frame 305 and the second frame 307 can be disposed interlaced horizontally or vertically.

Each of the second frames 307 is disposed between two of the first frames 305. The first frames 305 and the second frames 307 display the first images and the second images respectively. As shown in FIG. 1, the first images of the first frames 305 and the second images of the second frames 307 are projected to the left-eye and the right-eye of the viewer through a mask. In other words, the first images of the first frames 305 are the left-eye images received by the left-eye of the viewer, the second images of the second frames 307 are the right-eye images received by the right-eye of the viewer. The human brain merges the first images of the first frames 305 and the second images of the second frames 307 to achieve three-dimensional vision. Since the whole image is divided into first frames 305 and second frames 307 to display the first images and the second images individually, the resolution is reduced to half as a result.

To overcome the resolution reducing problem, the second pixel regions 303 are added in addition to the original first pixel regions 301 in the first frames 305 and the second frames 307 to display images in this embodiment, which improves the image resolution received by the left-eye and the right eye individually. The first pixel regions 301 and the second pixel regions 303 are arranged to be displayed at different times, hence double images are displayed, and the image resolution is doubled by the visual staying phenomenon of human eyes. As a result, the image resolution can be improved without adding real sub-pixel circuits.

As stated above, although the number of pixel regions received by the left-eye/right-eye is reduced to half because whole image is divided into the first frame 305 and the second frame 307, the image resolution can be kept the same by adding the second pixel regions 303 to display double image data.

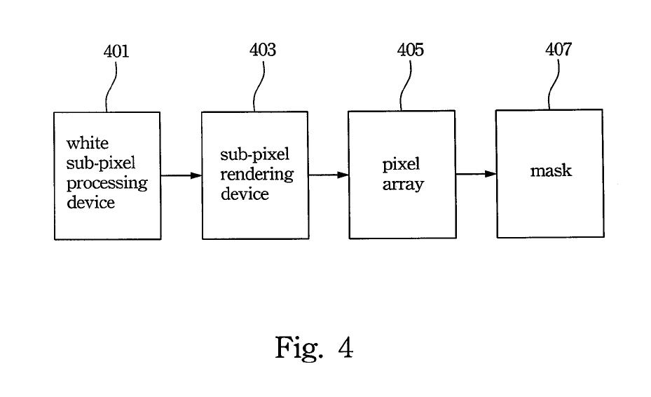

FIG. 4 shows the RGBW three-dimensional image display device according to one embodiment of the present invention. The RGBW three-dimensional image display device includes the white sub-pixel processing device 401, the sub-pixel rendering device 403, the pixel array 405, and the mask 407. The white sub-pixel processing device 401 generates signals required for the white sub-pixels. In order to display the images, the sub-pixel rendering device 403 provides data signals for the sub-pixels for grouping the sub-pixels as the first frames 305 and second frames 307 as shown in FIG. 3, in which several first pixel regions 301 and several second pixel regions 303 are defined in each first frame 305/second frame 307 to increase the image resolution. Pixel array 405 includes several sub-pixels, which receive the data signal from the sub-pixel rendering device 403 in order to display the images. The mask 407 projects the first images and the second images to the left-eye and right-eye of the viewer to form three-dimensional vision. The white sub-pixel processing device 401 and the sub-pixel rendering device 403 can be two different circuits or IC chips, also can be integrated into an IC chip.

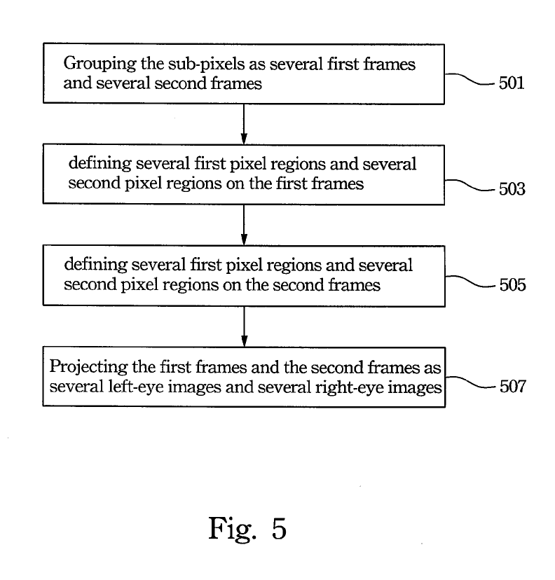

FIG. 5 shows the method to display three-dimensional images according to one embodiment of the present invention. The sub-pixels are grouped as several first frames and several second frames first (step 501), in which each second frame is disposed between two of the first frames on the pixel array.

Next, several first pixel regions and several second pixel regions are defined on the first frames (step 503), while several first pixel regions and several second pixel regions are also defined on the second frames (step 505). Each second pixel region has some sub-pixels in common with the adjacent first pixel regions, and each first frame doesn't overlap the second frames. The sub-pixels include the red sub-pixels, the green sub-pixels, the blue sub-pixels and the white sub-pixels, which can be arranged in stripe shapes or interlaced. These sub-pixels perform the sub-pixel rendering form.

Then, the first frame and the second frame are projected as several left-eye images and several right-eye images (step 507) in order to enable the viewer to be visible of three-dimensional vision. The mask is disposed between the pixel array and the viewer, and is disposed at a pre-determined distance from the pixel array.

According to the above embodiment, the three-dimensional display device and the method for displaying three-dimensional images thereof maintain the image resolution while produce the three-dimensional vision, which improves the image quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional image display device, comprising:
a pixel array having a plurality of sub-pixels;
a sub-pixel rendering device providing data signals for the sub-pixels to form a plurality of first frames and a plurality of second frames that include a plurality of first pixel regions and a plurality of second pixel regions, for displaying a plurality of first images and a plurality of second images, in which each second pixel region has some sub-pixels in common with the adjacent first pixel regions, each first frame doesn't overlap the second frames; and
a mask, disposed on the pixel array, projecting the first images and the second images.

2. The three-dimensional image display device of claim 1, wherein the mask is disposed between the pixel array and a viewer, and disposed at a pre-determined distance from the pixel array.

3. The three-dimensional image display device of claim 1, wherein each second frame is disposed between two of the first frames.

4. The three-dimensional image display device of claim 1, wherein the sub-pixels of the pixel array includes a plurality of red sub-pixels, a plurality of green sub-pixels, and a plurality of blue sub-pixels.

5. The three-dimensional image display device of claim 4, wherein the red sub-pixels, the green sub-pixels and the blue sub-pixels are arranged in stripe shapes respectively.

6. The three-dimensional image display device of claim 1, wherein the red sub-pixels, the green sub-pixels and the blue sub-pixels are interlaced arranged.

7. The three-dimensional image display device of claim 1, wherein the sub-pixels are arranged in sub-pixel rendering form.

8. The three-dimensional image display device of claim 1, wherein the sub-pixels of the pixel array include a plurality of red sub-pixels, a plurality of green sub-pixels, a plurality of blue sub-pixels, and a plurality of white sub-pixels.

9. The three-dimensional image display device of claim 1, wherein the first images are defined as a plurality of left-eye images, and the second images are defined as a plurality of right-eye images.

10. A method for displaying three-dimensional images, comprising:
forming a plurality of first frames and a plurality of second frames with a plurality of sub-pixels;
defining the first frames as a plurality of first pixel regions and a plurality of second pixel regions; and
defining the second frames as the first pixel regions and the second pixel regions,
wherein each second pixel region has some sub-pixels in common with the adjacent first pixel regions, and each first frame doesn't overlap the second frames.

11. The method for displaying of claim 10, further comprising projecting the first frames and the second frames as a plurality of left-eye images and a plurality of right-eye images through a mask.

12. The method for displaying of claim 11, wherein the mask is disposed between a viewer and a pixel array and disposed at a distance from the pixel array.

13. The method for displaying of claim 10, wherein each of the second frames is disposed between two of the first frames.

14. The method for displaying of claim 10, wherein the sub-pixels include a plurality of red sub-pixels, a plurality of green sub-pixels, and a plurality of blue sub-pixels.

15. The method for displaying of claim 14, wherein the red sub-pixels, the green sub-pixels, and the blue sub-pixels are arranged in stripe shapes respectively.

16. The method for displaying of claim 14, wherein the red sub-pixels, the green sub-pixels, and the blue sub-pixels are interlaced arranged.

17. The method for displaying of claim 10, wherein the sub-pixels include a plurality of red sub-pixels, a plurality of green sub-pixels, a plurality of blue sub-pixels, and a plurality of white sub-pixels.

18. The method for displaying of claim 10, wherein the sub-pixels are arranged in sub-pixel rendering form.
